(19) United States
(12) Patent Application Publication
(10) Pub. No.: US 2026/0211207 A1
(43) Pub. Date: Jul. 23, 2026

(54) LENS BARREL AND IMAGING DEVICE

(71) Applicant: NIKON CORPORATION, Tokyo (JP)

(72) Inventors: Kunihiko SHIMIZU, Tokyo (JP); Takuji HAMASAKI, Tokyo (JP); Takumi NAKANO, Tokyo (JP); Koji NAGAOKA, Tokyo (JP)

(73) Assignee: NIKON CORPORATION, Tokyo (JP)

(21) Appl. No.: 19/138,946

(22) PCT Filed: Dec. 19, 2023
(86) PCT No.: PCT/JP2023/045513

§ 371 Date: Jun. 13, 2025

(30) Foreign Application Priority Data
Dec. 23, 2022 (JP) 2022-206955

(51) Int. Cl. G02B 7/04

(52) U.S. Cl. CPC G02B 7/04

(57) ABSTRACT

A lens barrel includes a first frame that holds a lens, a drive unit that includes a drive shaft and drives the first frame in a direction of an optical axis, and a second frame including at least two guide portions that guide driving of the first frame in the direction of the optical axis, wherein in a plane orthogonal to the optical axis, at least one of the at least two guide portions is disposed on a second straight line that is orthogonal to a first straight line passing through the drive shaft and the optical axis and passes through the optical axis.

### CROSS-REFERENCE TO RELATED APPLICATION

This application is a national stage application of the prior International Patent Application No. PCT/JP2023/045513, filed on Dec. 19, 2023, which is based upon and claims the benefit of priority of the prior Japanese Patent Application No. 2022-206955, filed on Dec. 23, 2022, the entire contents of which are incorporated herein by reference.

### FIELD

The present disclosure relates to a lens barrel and an imaging device.

### BACKGROUND

An optical device such as a lens barrel is equipped with a lens moving device that moves a lens group during a zooming operation and a focusing operation.

It is desired to improve the accuracy of position control of the lens group.

### CITATION LIST

### Patent Literature

PTL 1: International Publication No. 2018/105200

### SUMMARY

According to a first aspect, a lens barrel includes: a first frame that holds a lens; a drive unit that includes a drive shaft and drives the first frame in a direction of an optical axis; and a second frame including at least two guide portions that guide driving of the first frame in the direction of the optical axis, wherein in a plane orthogonal to the optical axis, at least one of the at least two guide portions is disposed on a second straight line, which is orthogonal to a first straight line passing through the drive shaft and the optical axis and passes through the optical axis.

According to a second aspect, a lens barrel includes: a first frame that holds a lens; a drive unit that includes a drive shaft and drives the first frame in an optical axis direction; a second frame including at least two guide portions that guide driving of the first frame in the optical axis direction; an inner ring fixed to the first frame; and an outer ring rotatable relative to the inner ring, wherein an outer peripheral surface of the outer ring is in contact with the guide portion.

According to a third aspect, a lens barrel is a lens barrel including a first frame and a second frame that move relative to each other in an optical axis direction, and includes at least two drip-proof members provided in a gap that is between the first frame and the second frame and connects an exterior and interior of the lens barrel.

According to a fourth aspect, an imaging device includes the above lens barrel.

The configuration of the embodiment described later may be appropriately modified, and at least a part thereof may be replaced with another configuration. Furthermore, the constituent elements whose arrangement is not particularly limited are not limited to the arrangement disclosed in the embodiment, and can be arranged at positions where the functions thereof can be achieved.

### BRIEF DESCRIPTION OF THE DRAWINGS

FIG. 1A and FIG. 1B are cross-sectional views illustrating a configuration of a camera including a lens barrel according to an embodiment, where FIG. 1A illustrates an infinite state, and FIG. 1B illustrates a closest state.

FIG. 2 is a perspective view of a first fixed barrel member.

FIG. 3 is an exploded perspective view of an optical system block unit.

FIG. 4A is an exploded perspective view of a moving block unit, and FIG. 4B is a perspective view of the moving block unit as viewed from an image plane side.

FIG. 5 is an enlarged view of a portion C1 enclosed by a dotted line in FIG. 1A.

FIG. 6 is a perspective view for describing a configuration of a drive mechanism.

FIG. 7 is a cross-sectional view for describing the configuration of the drive mechanism.

FIG. 8 is a view for describing an arrangement of first to third guide grooves.

FIG. 9A is a view schematically illustrating an arrangement example of first to third guide grooves according to a comparative example, and FIG. 9B is a view for describing a reason why the first guide groove and the second guide groove are arranged on a second straight line.

FIG. 10A is an enlarged view of a portion C2 enclosed by a dotted line in FIG. 1A and FIG. 10B is a cross-sectional view illustrating a drip-proof structure according to a comparative example.

### DESCRIPTION OF EMBODIMENTS

Hereinafter, a lens barrel according to an embodiment will be described in detail with reference to the drawings. The shapes and the scales such as the lengths, thicknesses, and other dimensions of the components illustrated in the embodiments are not necessarily identical to those of the actual ones, and some components may be omitted in the drawings for easy understanding. In some cross-sectional views, some components are not hatched.

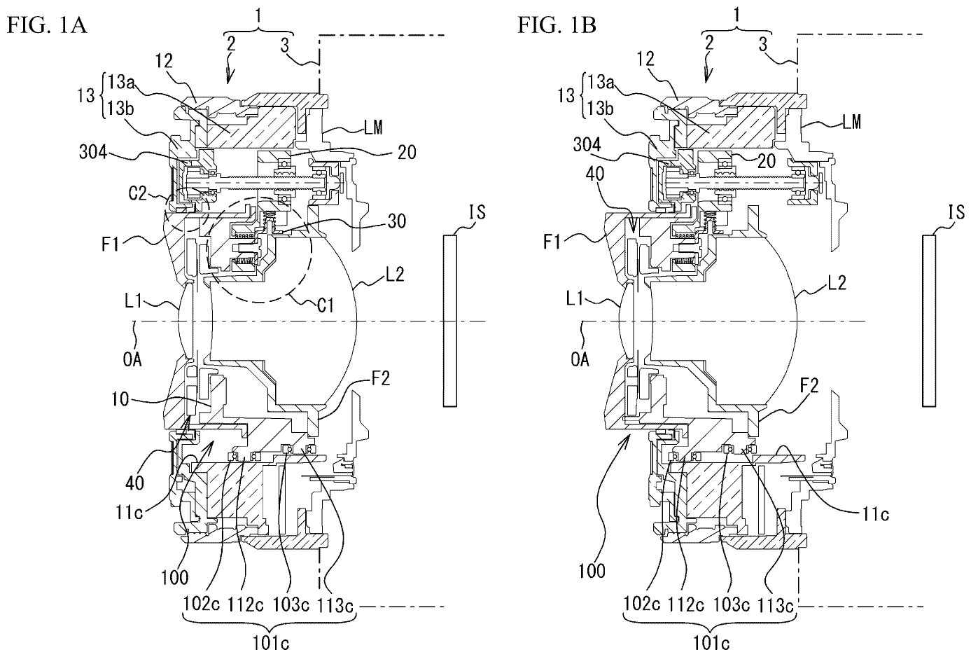

FIG. 1A and FIG. 1B are cross-sectional views illustrating a configuration of a camera 1 including a lens barrel 2 according to an embodiment, wherein FIG. 1A illustrates the infinite state, and FIG. 1B illustrates the closest state.

As illustrated in FIG. 1A and FIG. 1B, the camera 1 includes a camera body 3 and the lens barrel 2. The lens barrel 2 has a lens mount LM at a rear portion (base end portion) thereof, and is detachably mounted on the camera body 3 by the lens mount LM engaging with a body mount (not illustrated) of the camera body 3. In the present embodiment, the lens barrel 2 is detachable from the camera body 3, but this does not intend to suggest any limitation, and the lens barrel 2 and the camera body 3 may be integrated.

The camera body 3 includes an image sensor IS, a control unit (not illustrated), and the like. The image sensor IS is composed of a photoelectric conversion element such as a CCD (Charge Coupled Device), and converts a subject image formed by an imaging optical system (the lens barrel 2 mounted on the camera body 3) into an electrical signal.

The control unit includes a CPU (Central Processing Unit) and the like, and integrally controls the operation of the entire camera 1 related to photographing including focusing drive in the camera body 3 and the attached lens barrel 2.

The lens barrel 2 includes a fixed barrel 13, a focus operation ring 12, and an optical system block unit 100 that moves in the optical axis OA direction in accordance with an operation of the focus operation ring 12 and an operation by the user via the camera body 3 and the like. A first fixed barrel member 13a and a second fixed barrel member 13b are disposed in the fixed barrel 13. The optical system block unit 100 is an example of a first frame, and the first fixed barrel member 13a is an example of a second frame.

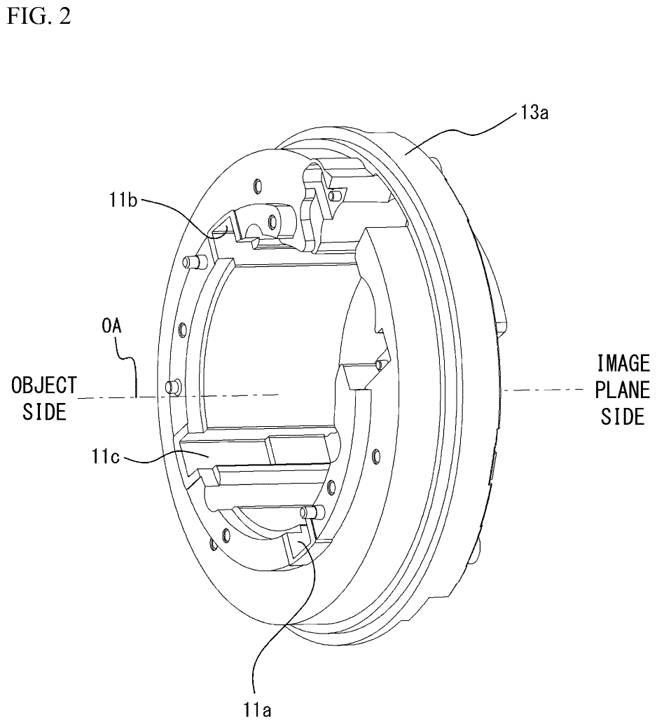

FIG. 2 is a perspective view of the first fixed barrel member 13a. As illustrated in FIG. 2, a first guide groove 11a, a second guide groove 11b, and a third guide groove 11c for guiding the optical system block unit 100 in the optical axis OA direction are formed on the inner circumference of the first fixed barrel member 13a. Each of the first to third guide grooves 11a to 11c is a linear groove extending in the optical axis OA direction, and the bottom surface thereof has a stepped shape in which the bottom surface on the object side is located radially further outward than the bottom surface on the image plane side (see FIG. 1A and FIG. 1B). Details of the arrangement of the first to third guide grooves 11a to 11c will be described later. The first to third guide grooves 11a to 11c are examples of guide portions.

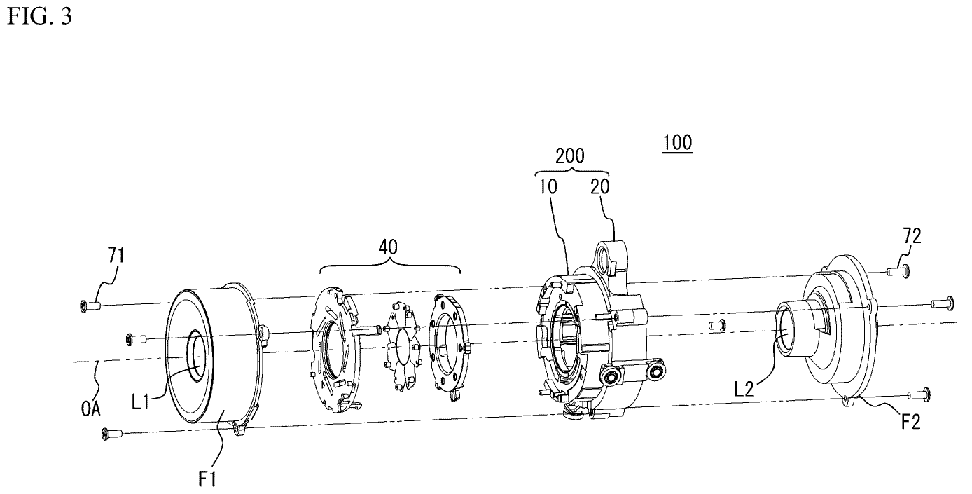

FIG. 3 is an exploded perspective view of the optical system block unit 100. As illustrated in FIG. 1A, FIG. 1B, and FIG. 3, the optical system block unit 100 includes a lens holding frame F1, a lens group L1, a diaphragm mechanism 40, a moving block unit 200, a lens holding frame F2, and a lens group L2.

The lens groups L1 and L2 are sequentially arranged along the common optical axis OA, the lens group L1 is held by the lens holding frame F1, and the lens group L2 is held by the lens holding frame F2. The lens groups L1 and L2 are focus lens groups. As described above, the optical system block unit 100 including the lens groups L1 and L2 moves in the optical axis OA direction in accordance with the operation of the focus operation ring 12 and the operation by the user via the camera body 3 and the like. That is, the lens barrel 2 according to the present embodiment adopts a focusing system of an entire extension system in which the whole optical system is driven as a focus group. This makes it possible to reduce the entire length of the lens barrel 2 in the optical axis OA direction, for example, as compared with a case where an inner focus system is adopted. That is, the lens barrel 2 can be downsized.

Each of the lens groups L1 and L2 may include one lens or may include a plurality of lenses. Further, although a lens barrel including two lens groups will be described as an example, the number of lens groups may be one or three or more.

The diaphragm mechanism 40 is disposed between the lens groups L1 and L2.

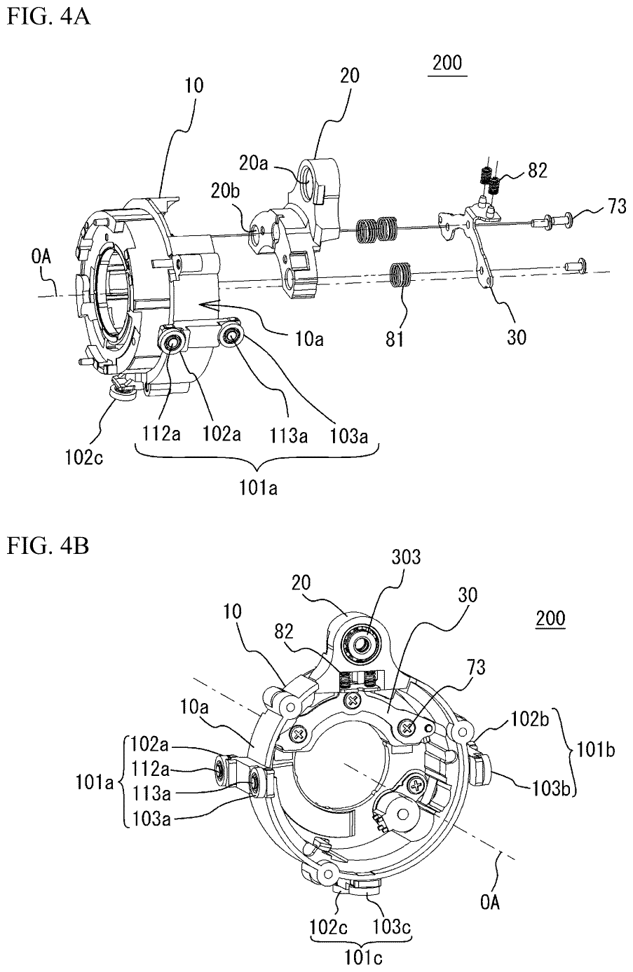

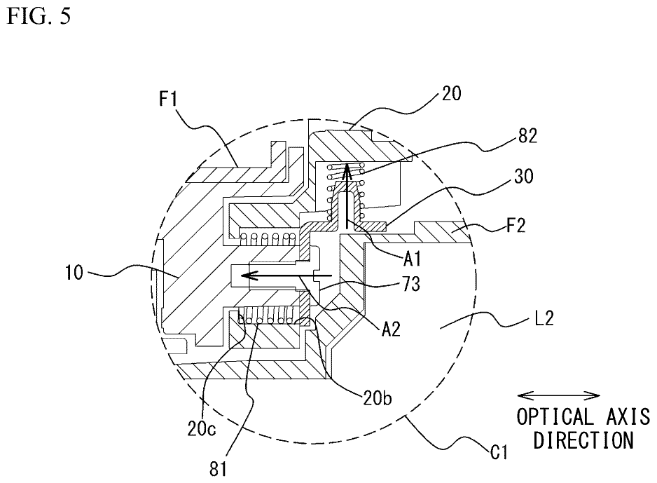

FIG. 4A is an exploded perspective view of the moving block unit 200, and FIG. 4B is a perspective view of the moving block unit 200 as viewed from the image plane side. FIG. 5 is an enlarged view of a portion C1 enclosed by a dotted line in FIG. 1A. As illustrated in FIG. 4A and FIG. 4B, the moving block unit 200 includes a coupling portion 10, a moving portion 20, and a biasing-portion holding portion 30.

The biasing-portion holding portion 30 holds first biasing members 81 and second biasing members 82, and is fixed to the coupling portion 10 by screws 73. As illustrated in FIG. 5, a part of the moving portion 20 is disposed between the coupling portion 10 and the biasing-portion holding portion 30.

As illustrated in FIG. 5, in the present embodiment, the first biasing member 81 is a coil spring. As illustrated in FIG. 5, the first biasing member 81 is accommodated in a hole 20b provided in the moving portion 20, one end thereof is in contact with a bottom 20c of the hole 20b, and the other end thereof is in contact with the biasing-portion holding portion 30. As a result, as indicated by an arrow A2 in FIG. 5, the moving portion 20 is biased toward the coupling portion 10, and thus, the backlash between the moving portion 20 and the coupling portion 10 in the optical axis direction is reduced, and when the moving portion 20 moves in the optical axis direction, the coupling portion 10 also moves in the optical axis direction. The first biasing member 81 is not limited to the coil spring as long as it can bias the moving portion 20 toward the coupling portion 10, and may be a leaf spring or the like.

As illustrated in FIG. 4B and FIG. 5, the second biasing member 82 is a coil spring, and one end thereof is in contact with the moving portion 20 and the other end thereof is in contact with the biasing-portion holding portion 30. As a result, as indicated by an arrow A1 in FIG. 5, the moving portion 20 is biased toward a lead screw 302 described later. The second biasing member 82 is not limited to the coil spring as long as it can bias the moving portion 20 toward the lead screw 302, and may be a leaf spring or the like.

As illustrated in FIG. 3, the lens holding frame F1 and the lens holding frame F2 are connected to the coupling portion 10. Specifically, the lens holding frame F1 is fixed to the coupling portion 10 by screws 71, and the lens holding frame F2 is fixed to the coupling portion 10 by screws 72.

As described above, the coupling portion 10 is connected to the moving portion 20 by the first biasing members 81 and the biasing-portion holding portion 30. As a result, when the moving portion 20 moves in the optical axis OA direction, the lens holding frames F1 and F2 move in the optical axis OA direction.

As illustrated in FIG. 4A, FIG. 4B, and the like, the coupling portion 10 includes a cylindrical portion 10a, and a first groove engagement portion 101a, a second groove engagement portion 101b, and a third groove engagement portion 101c that protrude from the cylindrical portion 10a in the radial direction.

The first groove engagement portion 101a includes a front protrusion 112a and a rear protrusion 113a that protrude in the radial direction and are disposed apart from each other in the optical axis OA direction, a front bearing 102a, and a rear bearing 103a. The outer periphery of the front protrusion 112a is fitted to the inner ring of the front bearing 102a, and the outer periphery of the rear protrusion 113a is fitted to the inner ring of the rear bearing 103a. Therefore, the front bearing 102a and the rear bearing 103a are disposed to be spaced apart from each other in the optical axis OA direction.

The front bearing 102a and the rear bearing 103a engage with the first guide groove 11a. The front bearing 102a and the rear bearing 103a move along the first guide groove 11a while rotating. As a result, the friction generated when the first groove engagement portion 101a moves within the first guide groove 11a is rolling friction. Therefore, for example, compared to a case where the front protrusion 112a and the rear protrusion 113a engage with the first guide groove 11a without bearings, the sliding resistance when the first groove engagement portion 101a moves within the first guide groove 11a is reduced, and the load applied to the drive unit (a stepping motor 301 described later) for moving the moving portion 20 in the optical axis OA direction can be reduced.

Similarly to the first groove engagement portion 101a, the second groove engagement portion 101b includes a front protrusion 112b (not illustrated) and a rear protrusion 113b (not illustrated) that protrude in the radial direction and are disposed apart from each other in the optical axis OA direction, a front bearing 102b, and a rear bearing 103b. The outer periphery of the front protrusion 112b is fitted to the inner ring of the front bearing 102b, and the outer periphery of the rear protrusion 113b is fitted to the inner ring of the rear bearing 103b. As a result, the front bearing 102b and the rear bearing 103b are disposed to be spaced apart from each other in the optical axis OA direction.

The front bearing 102b and the rear bearing 103b engage with the second guide groove 11b. As a result, the friction generated when the second groove engagement portion 101b moves within the second guide groove 11b is rolling friction. Therefore, for example, compared to a case where the front protrusion 112b and the rear protrusion 113b engage with the second guide groove 11b without bearings, the load applied to the stepping motor 301 when the second groove engagement portion 101b moves within the second guide groove 11b can be reduced.

The third groove engagement portion 101c includes a front protrusion 112c and a rear protrusion 113c (see FIG. 1A and FIG. 1B) that protrude in the radial direction and are disposed apart from each other in the optical axis OA direction, a front bearing 102c, and a rear bearing 103c, similarly to the first groove engagement portion 101a. The outer periphery of the front protrusion 112c is fitted to the inner ring of the front bearing 102c, and the outer periphery of the rear protrusion 113c is fitted to the inner ring of the rear bearing 103c. As a result, the front bearing 102c and the rear bearing 103c are disposed to be spaced apart from each other in the optical axis OA direction.

The front bearing 102c and the rear bearing 103c engage with the third guide groove 11c. As a result, the friction generated when the third groove engagement portion 101c moves within the third guide groove 11c is rolling friction. Therefore, for example, compared to a case where the front protrusion 112c and the rear protrusion 113c engage with the third guide groove 11c without bearings, the load applied to the stepping motor 301 when the third groove engagement portion 101c moves in the third guide groove 11c can be reduced.

In the present embodiment, the rear bearing 103a is located radially further inward than the front bearing 102a, the rear bearing 103b is located radially further inward than the front bearing 102b, and the rear bearing 103c is located radially further inward than the front bearing 102c. Therefore, as illustrated in FIG. 1B, a space where other members such as a flexible substrate can be disposed can be secured at the outer peripheral sides of the rear bearings 103a to 103c. In addition, this configuration allows the distance between the front bearing 102a and the rear bearing 103a, the distance between the front bearing 102b and the rear bearing 103b, and the distance between the front bearing 102c and the rear bearing 103c to be lengthened. This can prevent the central axes of the lens groups L1 and L2 from being inclined with respect to the optical axis OA, and thus can improve the optical performances of the lens barrel 2. The distance between the front bearing 102a and the rear bearing 103a, the distance between the front bearing 102b and the rear bearing 103b, and the distance between the front bearing 102c and the rear bearing 103c may be the same as or different from each other.

As described above, the focusing system of the lens barrel 2 according to the present embodiment is the entire extension system, and thus the optical system block unit 100 protrudes from the lens barrel 2. In this case, when the lens barrel 2 is dropped, an impact is directly applied to the focus lens group. By supporting the optical system block unit 100 by the first to third guide grooves 11a to 11c and the first to third groove engagement portions 101a to 101c according to the present embodiment, it is possible to increase the strength against impact compared to a case where the optical system block unit 100 is supported by one guide bar, for example.

As illustrated in FIG. 4A, the moving portion 20 has a hole 20a that accommodates a lead screw engagement portion 303 included in a drive mechanism 300 that drives the optical system block unit 100, and the holes 20b that accommodate the first biasing members 81 described above. The drive mechanism 300 that drives the optical system block unit 100 will be described.

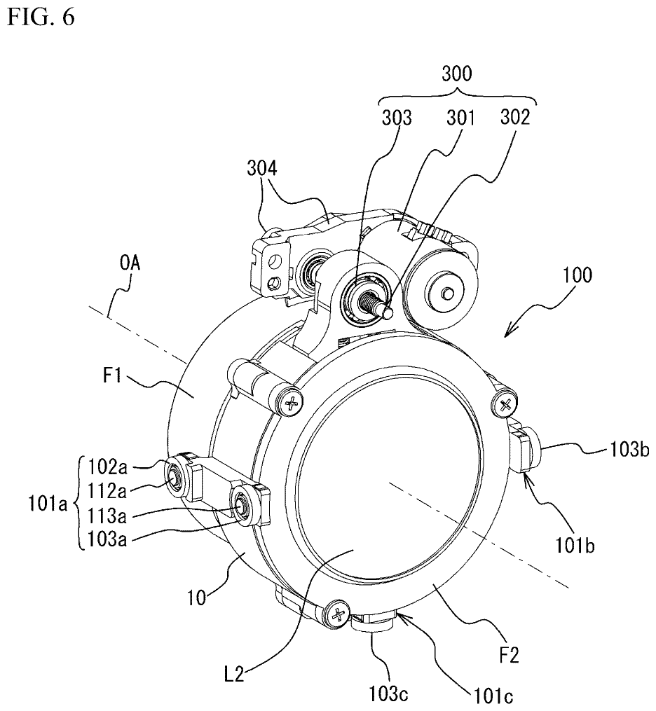

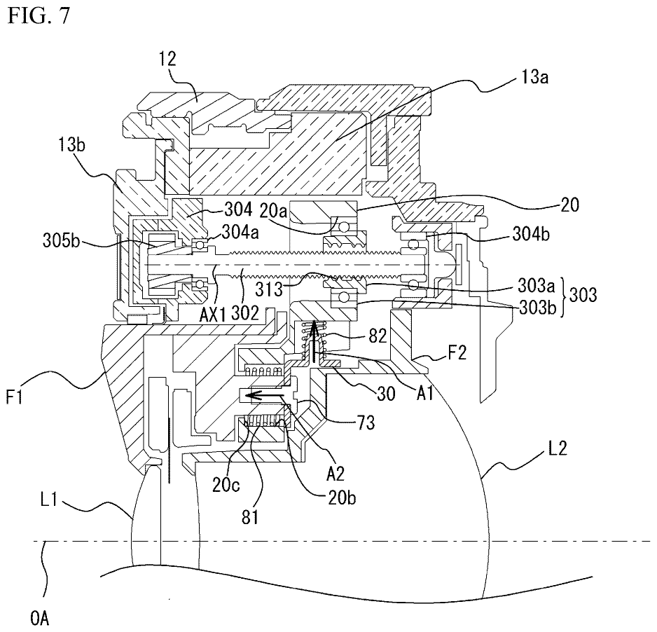

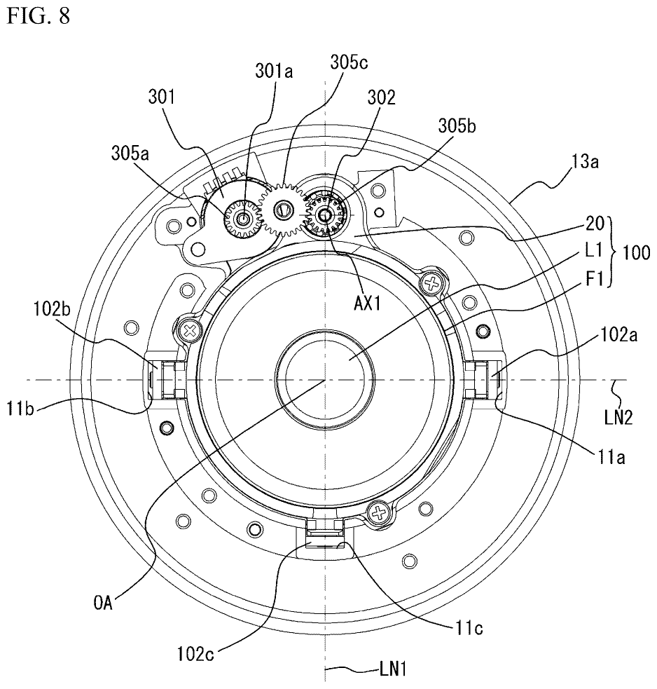

FIG. 6 is a perspective view for describing the configuration of the drive mechanism 300, and is a perspective view of the drive mechanism 300 and the optical system block unit 100 as viewed from the image plane side. FIG. 7 is a cross-sectional view for describing the configuration of the drive mechanism 300. FIG. 8 is a view for describing the arrangement of the first to third guide grooves, and is a plan view of the optical system block unit 100 and the first fixed barrel member 13a as viewed from the object side.

As illustrated in FIG. 6, the drive mechanism 300 includes the stepping motor 301, the lead screw 302, and the lead screw engagement portion 303.

In the present embodiment, the stepping motor 301 is used as a drive source for the lead screw 302. When the user operates the focus operation ring 12 or operates the camera body 3, an in-lens control unit (not illustrated) rotates the lead screw 302 according to an operation amount, and the optical system block unit 100 moves in the optical axis OA direction.

In the present embodiment, the position of the optical system block unit 100 is controlled by open-loop control of the stepping motor 301. That is, the position of the optical system block unit 100 is not detected and fed back to the in-lens control unit. This eliminates the need for a position detection unit (feedback sensor, etc.) for feedback control of the position of the optical system block unit 100, thereby enabling miniaturization of the lens barrel 2 and cost reduction. Since the position of the optical system block unit 100 is represented by the number of steps (the number of rotations) of the stepping motor 301, position data represented by the number of steps is transmitted to the camera body 3 and the in-lens control portion as necessary.

As illustrated in FIG. 8, in the present embodiment, an output shaft 301a of the stepping motor 301 is connected to the lead screw 302 through gears 305a to 305c. Specifically, as illustrated in FIG. 8, the output shaft 301a is disposed on the object side of the stepping motor 301. The gear 305a is attached to the object side end of the output shaft 301a of the stepping motor 301, the gear 305b is attached to the object side end of the lead screw 302, and the gear 305c, which engages with the gears 305a and 305b, is disposed between the gears 305a and 305b. The total length of the stepping motor 301 and the output shaft 301a in the optical axis direction is substantially equal to the length of the lead screw 302 in the optical axis direction. Therefore, the stepping motor 301 and the output shaft 301a thereof are arranged in parallel with the lead screw 302 and closer to the image plane than the gears 305a to 305c. As a result, the rotational force is transmitted from the object side end of the output shaft 301a of the stepping motor 301 to the object side end of the lead screw 302 via the gear 305c. With this configuration, the output shaft 301a of the stepping motor 301 and the lead screw 302 are arranged while overlapping, and thus the entire length of the lens barrel 2 in the optical axis OA direction can be reduced as compared with the case where the output shaft and the lead screw are directly connected. The total length of the stepping motor 301 and the output shaft 301a in the optical axis direction and the length of the lead screw 302 in the optical axis direction can be changed as appropriate.

As illustrated in FIG. 7, the lead screw 302 is rotatably supported by a lead screw support mechanism 304 and the first fixed barrel member 13a. In the present embodiment, the lead screw support mechanism 304 rotatably supports one end of the lead screw 302 via a bearing 304a, and the first fixed barrel member 13a rotatably supports the other end of the lead screw 302 via a bearing 304b. By supporting both ends of the lead screw 302 with the bearings in this manner, it is possible to reduce a load applied to the stepping motor 301 when the lead screw 302 is rotated. In the present embodiment, the position of the optical system block unit 100 is controlled by the open loop control of the stepping motor 301. Therefore, when an excessive load is applied to the stepping motor 301, a desired moving amount of the optical system block unit 100 may not be obtained with respect to a predetermined driving amount of the stepping motor 301. Therefore, in the present embodiment, the load on the stepping motor 301 is reduced, thereby improving the position control accuracy of the optical system block unit 100.

As illustrated in FIG. 7, the lead screw engagement portion 303 includes a ring-shaped member 303a and a bearing 303b. The outer periphery of the ring-shaped member 303a is fitted to the inner ring of the bearing 303b. The outer periphery of the bearing 303b is fitted to the inner periphery of the hole 20a of the moving portion 20.

Grooves 313 that are in contact with the screw groove of the lead screw 302 are formed on the inner circumference of the ring-shaped member 303a. The groove 313 is a circumferential groove formed over the entire circumference of the inner circumference of the ring-shaped member 303a.

The ring-shaped member 303a is biased by the second biasing members 82 toward the lead screw 302 in a direction orthogonal to the axis AX1 direction of the lead screw 302 as indicated by an arrow A1 in FIG. 7. This causes the grooves 313 of the ring-shaped member 303a to be pressed against the screw groove of the lead screw 302, thereby reducing backlash between the ring-shaped member 303a and the lead screw 302. In addition, since the lead screw engagement portion 303 is accommodated in the hole 20a formed in the moving portion 20, the moving portion 20 and the lead screw engagement portion 303 are connected to each other.

Since the ring-shaped member 303a is rotatably supported, when the lead screw 302 rotates, the ring-shaped member 303a moves in the axial direction of the lead screw 302 while being pushed by the flank surface of the screw groove of the lead screw 302 while rotating. This causes the moving portion 20, which engages with the lead screw engagement portion 303, to also move in the axial direction of the lead screw 302. The optical system block unit 100 is guided by the first to third guide grooves 11a to 11c of the first fixed barrel member 13a and moves in the optical axis OA direction along with the movement of the moving portion 20.

Since the ring-shaped member 303a moves in the direction of the axis AX1 of the lead screw 302 while rotating, the friction generated between the ring-shaped member 303a and the lead screw 302 is rolling friction. This reduces the load on the stepping motor 301 when the optical system block unit 100 is moved in the axial direction of the lead screw 302, thereby improving the position control accuracy of the optical system block unit 100. The structure disclosed in Japanese Patent Application No. 2021-156263 may be applied to the structure of the lead screw engagement portion 303.

Next, the arrangement of the first to third guide grooves 11a to 11c of the first fixed barrel member 13a will be described. In the present embodiment, as illustrated in FIG. 8, the first guide groove 11a and the second guide groove 11b are disposed on a second straight line LN2 that is orthogonal to a first straight line LN1 passing through the axis AX1 of the lead screw 302 and the optical axis OA and passes through the optical axis OA in a plane orthogonal to the optical axis OA. The third guide groove 11c is disposed on the first straight line LN1.

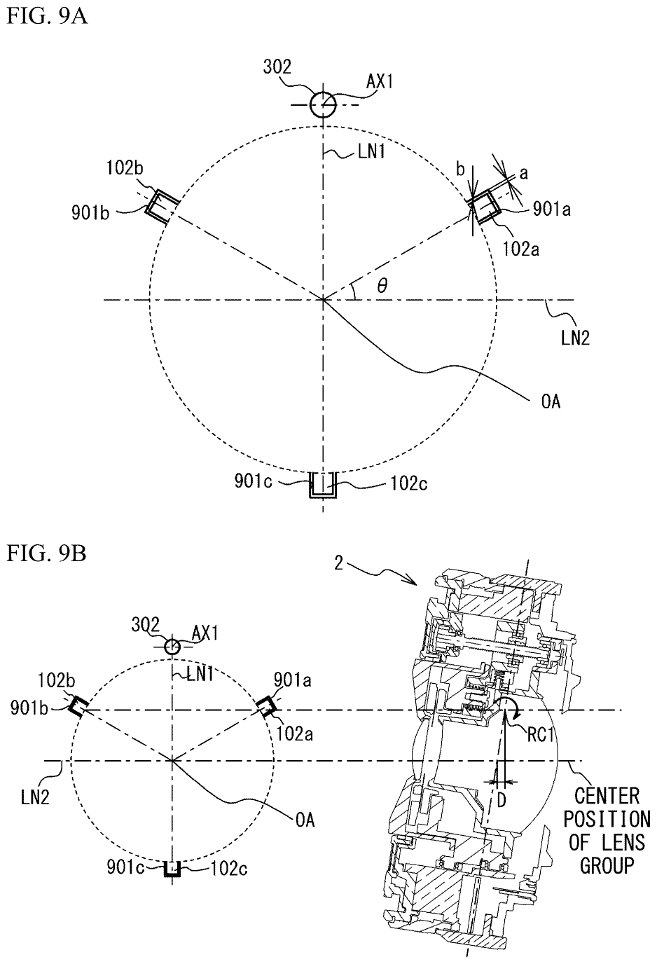

The reason why the first to third guide grooves 11a to 11c are arranged as described above will be described. FIG. 9A is a view schematically illustrating an arrangement example of a first guide groove 901a, a second guide groove 901b, and a third guide groove 901c according to a comparative example. In the comparative example, the first to third guide grooves 901a to 901c are arranged at intervals of 120 degrees. In this arrangement, when the respective backlash gaps between the first to third guide grooves 901a to 901c and, for example, the front bearings 102a to 102c are represented by a, the backlash gap b in the direction parallel to the first straight line LN1 passing through the axis AX1 of the lead screw 302 and the optical axis OA is, for example, b=a/cos θ in the first guide groove 901a, and is greater than the designed backlash gap a, and thus, the optical system block unit 100 has a large backlash in the pitch direction in FIG. 9A, and the driving accuracy is affected by that amount. Therefore, in the present embodiment, the first guide groove 11a and the second guide groove 11b are disposed at the position of θ=0° where b=a, that is, on the second straight line LN2 orthogonal to the first straight line LN1. In this manner, the tilting of the optical system block unit 100 is reduced, thereby improving the positional accuracy of the optical system block unit 100. In addition, the third guide groove 11c on the first straight line LN1 is involved in the backlash in the yaw direction in FIG. 9A, but does not affect the driving performance near the optical axis center because of the position of the fulcrum. Further, in the driving performance of the peripheral portion away from the optical axis, since the direction of the third guide groove 11c is the vertical direction in FIG. 9A, the backlash is minimized, and the backlash in the yaw direction is also reduced, so that the driving accuracy is not greatly affected.

FIG. 9B is a view for describing another reason why the first guide groove 11a and the second guide groove 11b are arranged on the second straight line LN2. As in FIG. 9A, the first to third guide grooves 901a to 901c are arranged at intervals of 120 degrees. Here, as illustrated in the right side of FIG. 9B, it is assumed that the entire lens barrel 2 is tilted about the position (rotation center RC1) where the first guide groove 901a or the second guide groove 901b is provided. In this case, the position of the rotation center RC1 is shifted from the center position of the lens group by the amount indicated by D. The shift amount D is a shift in the optical axis direction due to the tilt of the lens, and causes an accuracy error. By arranging the first guide groove 11a and the second guide groove 11b on the second straight line LN2, accuracy errors due to the position of the rotation center of the lens barrel 2 can be reduced. The third guide groove 11c on the first straight line LN1 is involved in the backlash in the yaw direction in FIG. 9A, but does not affect the driving performance near the optical axis center because of the position of the fulcrum. Further, in the driving performance of the peripheral portion away from the optical axis, since the direction of the third guide groove 11c is the vertical direction in FIG. 9A, the backlash is minimized, and the backlash in the yaw direction is also reduced, so that the accuracy errors are not greatly affected.

As described above, in the present embodiment, the load applied to the stepping motor 301 is reduced, and the position control accuracy of the optical system block unit 100 is improved by arranging the first to third guide grooves 11a to 11c described above.

### Drip-Proof Structure

In the lens barrel 2 according to the present embodiment, the optical system block unit 100 moves in the optical axis OA direction, and the lens holding frame F1 may protrude from the lens barrel 2 as illustrated in FIG. 1B. In this case, it is undesirable for water droplets adhering to the lens holding frame F1 due to rain fall or the like to penetrate into the interior of the lens barrel 2 through a gap between the second fixed barrel member 13b and the lens holding frame F1. Therefore, the lens barrel 2 has a drip-proof structure for preventing the water droplets adhering to the lens holding frame F1 from entering the interior of the lens barrel 2.

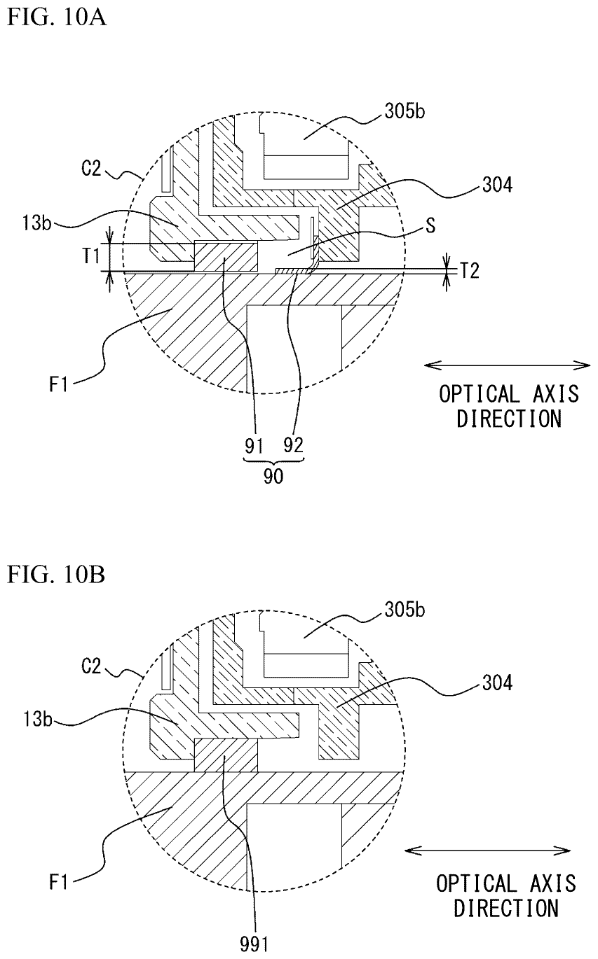

FIG. 10A is a view for describing a drip-proof structure 90 according to the present embodiment, and is an enlarged view of a portion C2 enclosed by a dotted line in FIG. 1A.

As illustrated in FIG. 10A, the lens barrel 2 according to the present embodiment includes the lens holding frame F1 that moves in the optical axis direction, and the second fixed barrel member 13b that is disposed radially further outward than the lens holding frame F1. When the lens holding frame F1 moves in the optical axis direction, the positional relationship between the lens holding frame F1 and the second fixed barrel member 13b in the optical axis direction changes relatively. A space S is formed as a gap connecting the exterior and interior of the lens barrel 2 between the lens holding frame F1 and the second fixed barrel member 13b. The drip-proof structure 90 is provided in the space S. The drip-proof structure 90 includes a first drip-proof member 91 and a second drip-proof member 92 formed of a material different from that of the first drip-proof member 91. The lens holding frame F1 is an example of a first frame, and the second fixed barrel member 13b is an example of a second frame. In the present embodiment, the lens holding frame F1 is movable in the optical axis OA direction with respect to the second fixed barrel member 13b, and the lens holding frame F1 and the second fixed barrel member 13b do not rotate relative to each other in the circumferential direction.

The first drip-proof member 91 and the second drip-proof member 92 are arranged side by side in the optical axis direction, and the first drip-proof member 91 is arranged closer to the object side than the second drip-proof member 92.

In the present embodiment, the first drip-proof member 91 is an elastic member (a member having a cushioning property) having water absorbency, and is disposed so as to surround the outer periphery of the lens holding frame F1. Examples of the material of the first drip-proof member 91 include a nonwoven fabric structure, synthetic leather, raised fabric, and flocked fabric. In the present embodiment, the first drip-proof member 91 is a nonwoven fabric structure with a water repellent agent coated on a surface facing the lens holding frame F1. The thickness of the first drip-proof member 91 is substantially constant in the optical axis direction, and the cross section of the first drip-proof member 91 is rectangular.

A clearance is provided between the first drip-proof member 91 and the lens holding frame F1. That is, the first drip-proof member 91 and the lens holding frame F1 are not in contact with each other. This reduces sliding resistance as compared with a case where the first drip-proof member 91 is in contact with the lens holding frame F1, and can reduce a driving load when the optical system block unit 100 moves in the optical axis OA direction. Therefore, the posture of the optical system block unit 100 is stabilized, which improves the optical performance of the lens barrel 2 and reduces the load on the stepping motor 301. This makes it possible to improve the accuracy of position control of the optical system block unit 100.

The second drip-proof member 92 is an elastic member coated with a coating for improving slidability, and is formed in a ring shape. The second drip-proof member 92 is, for example, a rubber sheet coated with a coating for improving the slidability. The second drip-proof member 92 has a substantially constant thickness and is disposed so as to have an inverted L-shaped cross section. One end of the inner circumferential surface of the second drip-proof member 92 is fixed so as to be in contact with the lens holding frame F1, and the other end is fixed to the object side surface of the lead screw support mechanism 304 fixed to the second fixed barrel member 13b.

When the optical system block unit 100 is moved from the closest state to the infinite state, for example, the water-repellent property of the first drip-proof member 91 prevents or reduces the entry of water droplets adhering to the lens holding frame F1 into the lens barrel 2 by the drip-proof structure 90. Further, even when water droplets enter the interior of the lens barrel 2 (the space S in FIG. 10A), the second drip-proof member 92 can prevent the water droplets from entering the further interior of the lens barrel 2 (toward the image plane side with respect to the lead screw support mechanism 304 and the second fixed barrel member 13b). The water droplets that have entered the space S are absorbed by the first drip-proof member 91 having water absorbency, and evaporate from the first drip-proof member 91 with the passage of time. Even if there are water droplets that are not absorbed by the first drip-proof member 91, the second drip-proof member 92 is provided, so that it is possible to reliably prevent the water droplets from entering the interior of the lens barrel 2.

As a result, the drip-proof structure 90 can obtain a drip-proof property equivalent to that of a drip-proof structure of a comparative example illustrated in FIG. 10B, in which, for example, a nonwoven fabric structure 991 is crushed and brought into contact with the lens holding frame F1. If the nonwoven fabric structure 991 is crushed to contact the lens holding frame F1, when the optical system block unit 100 moves in the optical axis OA direction, friction occurs between the nonwoven fabric structure 991 and the lens holding frame F1, causing driving resistance, and applying a load to the stepping motor 301. When a load is applied to the stepping motor 301, even if the stepping motor 301 is driven by a predetermined amount, the amount of movement of the optical system block unit 100 may not accurately correspond to the predetermined amount because of the driving resistance. In the present embodiment, the first drip-proof member 91 is not in contact with the lens holding frame F1, and therefore, the load applied to the stepping motor 301 can be reduced. This improves the accuracy of position control of the optical system block unit 100.

The expression “the nonwoven fabric structure 991 is crushed” means that the height of the cross section of the nonwoven fabric structure 991 in a state of being assembled to the lens barrel is smaller than the height of the cross section of the nonwoven fabric structure 991 in a state of not being assembled to the lens barrel.

As described above in detail, according to the present embodiment, the lens barrel 2 includes: the optical system block unit 100 that holds the lens groups L1 and L2; the drive mechanism 300 that includes the lead screw 302 and drives the optical system block unit 100 in the optical axis OA direction; and the first fixed barrel member 13a having the first to third guide grooves 11a to 11c that guide the drive of the optical system block unit 100 in the optical axis OA direction, and in the plane orthogonal to the optical axis OA, the first guide groove 11a and the second guide groove 11b among the first to third guide grooves 11a to 11c are disposed on the second straight line LN2 that is orthogonal to the first straight line LN1 passing through the axis AX1 of the lead screw 302 and the optical axis OA and passes through the optical axis OA.

As described with reference to FIG. 9A and FIG. 9B, this improves the driving accuracy of the optical system block unit 100 and reduces the accuracy error, thereby improving the position control accuracy of the optical system block unit 100.

Furthermore, according to the present embodiment, the first to third guide grooves 11a to 11c are linear grooves disposed along the optical axis OA direction, and the optical system block unit 100 includes the front protrusions 112a to 112c and the rear protrusions 113a to 113c that protrude radially outward and are guided along the linear grooves. This makes it possible to guide the optical system block unit 100 in the optical axis OA direction.

According to the present embodiment, the optical system block unit 100 includes the front bearings 102a to 102c rotatable about the centers of the front protrusions 112a to 112c and the rear bearings 103a to 103c rotatable about the centers of the rear protrusions 113a to 113c.

This reduces the load on the stepping motor 301 when the optical system block unit 100 moves in the optical axis OA direction, thereby improving the position control accuracy of the optical system block unit 100.

Further, according to the present embodiment, the first to third guide grooves 11a to 11c include the first guide groove 11a and the second guide groove 11b disposed on the second straight line LN2, and the third guide groove 11c different from the first guide groove 11a and the second guide groove 11b. Since the optical system block unit 100 is supported by the three guide members, the strength of the lens barrel 2 against the impact can be increased as compared with a case where the optical system block unit 100 is supported by two or less guide members, for example.

The third guide groove 11c is disposed on the first straight line LN1. That is, the third guide groove 11c is disposed at a position facing the lead screw 302 in a plane orthogonal to the optical axis OA (disposed 180° apart). The third guide groove 11c is involved in the backlash in the yaw direction in FIG. 9A, but does not affect the driving performance near the optical axis center because of the position of the fulcrum. Further, in terms of the driving performance of the peripheral portion away from the optical axis, since the direction of the third guide groove 11c portion is the vertical direction in FIG. 9A, the backlash is minimized, and the backlash in the yaw direction is also reduced, so that the driving accuracy of the optical system block unit 100 is not affected. Therefore, it is possible to support the optical system block unit 100 without greatly affecting the driving accuracy of the optical system block unit 100, and the strength of the lens barrel 2 against an impact can be increased.

In addition, in the present embodiment, when the lead screw 302 rotates, the ring-shaped member 303a moves in the direction of the axis AX1 of the lead screw 302 while rotating, and thus the friction generated between the ring-shaped member 303a and the lead screw 302 is rolling friction. This reduces the load on the stepping motor 301 when the optical system block unit 100 is moved in the axial direction of the lead screw 302, thereby improving the position control accuracy of the optical system block unit 100.

According to the present embodiment, the lens barrel 2 includes the lens holding frame F1 and the second fixed barrel member 13b that move relative to each other in the optical axis OA direction, and the first drip-proof member 91 and the second drip-proof member 92 that are provided in the gap that is between the lens holding frame F1 and the second fixed barrel member 13b and that connects between the exterior and interior of the lens barrel 2. In other words, the lens barrel 2 includes the lens holding frame F1 that holds the lens group L1, the second fixed barrel member 13b that is disposed radially further outward than the lens holding frame F1 and whose position in the optical axis OA direction changes relative to the lens holding frame F1, and the first drip-proof member 91 and the second drip-proof member 92 that are disposed in the gap between the lens holding frame F1 and the second fixed barrel member 13b.

This can inhibit water droplets from entering the interior of the lens barrel 2 from the exterior of the lens barrel 2 through the gap between the lens holding frame F1 and the second fixed barrel member 13b. In addition, it is possible to inhibit light from entering from the gap between the lens holding frame F1 and the second fixed barrel member 13b.

In the present embodiment, the first drip-proof member 91 has higher water repellency than the second drip-proof member 92. This inhibits water droplets from entering thanks to the water repellency of the first drip-proof member 91.

In the present embodiment, the first drip-proof member 91 and the second drip-proof member 92 are arranged side by side in the optical axis OA direction, and the first drip-proof member 91 is arranged closer to the object side than the second drip-proof member 92. That is, the second drip-proof member 92 is disposed closer to the image plane side than the first drip-proof member 91. This prevents water droplets from getting further interior the lens barrel 2 by the second drip-proof member 92 even when there are water droplets that cannot be prevented from entering by the first drip-proof member 91.

In the present embodiment, the thickness T1 of at least a part of the first drip-proof member 91 in a plane orthogonal to the optical axis is larger than the thickness T2 of at least a part of the second drip-proof member 92. By making the thickness T1 of the first drip-proof member 91 disposed closer to the object side larger than the thickness T2 of the second drip-proof member 92, it is possible to effectively inhibit water droplets from entering from the object side of the gap between the lens holding frame F1 and the second fixed barrel member 13b.

In addition, in the present embodiment, a clearance is provided between the first drip-proof member 91 and the lens holding frame F1. This reduces the load on the stepping motor 301 compared to a case where the first drip-proof member 91 and the lens holding frame F1 are in contact, thereby improving the position control accuracy of the optical system block unit 100.

In the above embodiment, the stepping motor 301 is used as a drive source for rotationally driving the lead screw 302, but an ultrasonic motor, a VCM motor, or the like may be used instead of the stepping motor 301. Further, a position detection unit may be provided to perform feedback control.

In the above embodiment, the first to third guide grooves 11a to 11c and the first to third groove engagement portions 101a to 101c are engaged with each other, respectively, but a combination of a shaft-shaped guide bar and an engagement portion that engages with the guide bar may be used as the linear guide mechanism. In this case, two or more linear guide mechanisms are provided, and two linear guide mechanisms are disposed on the second straight line LN2.

In the above embodiment, in the first to third groove engagement portion 101a to 101c, the front bearings 102a to 102c and the rear bearings 103a to 103c are engaged with the first to third guide grooves 11a to 11c, respectively, but the front bearings 102a to 102c and the rear bearings 103a to 103c may be omitted, and the front protrusions 112a to 112c and the rear protrusions 113a to 113c may be engaged with the first to third guide grooves 11a to 11c, respectively. Further, one of the front bearing 102a and the rear bearing 103a may be omitted, one of the front bearing 102b and the rear bearing 103b may be omitted, or one of the front bearing 102c and the rear bearing 103c may be omitted. In particular, even when at least one of the front bearing 102c or the rear bearing 103c is omitted, the effect of inhibiting the tilting of the moving portion 20 can be maintained because the first guide groove 11a and the second guide groove 11b are disposed on the second straight line LN2.

In the above embodiment, the first guide groove 11a and the second guide groove 11b are disposed on the second straight line LN2, but may be disposed at positions offset from the second straight line LN2 within a predetermined range. For example, in a plane orthogonal to the optical axis OA, at least a part of the first guide groove 11a is disposed on second straight line LN2, and at least a part of the second guide groove 11b is also disposed on second straight line LN2. In particular, in a plane orthogonal to the optical axis OA, an angle between a straight line connecting the optical axis OA and the center of the first guide groove 11a and the second straight line LN2 is to be within a range of ±15°. In addition, the angle between the straight line connecting the optical axis OA and the center of the second guide groove 11b and the second straight line LN2 is to be within a range of ±15°.

In the above embodiment, the third guide groove 11c may be omitted. Further, the third guide groove 11c is disposed on the first straight line LN1, but may be disposed at a position offset from the first straight line LN1 within a predetermined range. For example, in a plane orthogonal to the optical axis OA, at least a part of the third guide groove 11c is to be disposed on the first straight line LN1. Specifically, in a plane orthogonal to the optical axis OA, an angle between a straight line connecting the optical axis OA and the center of the third guide groove 11c and the first straight line LN1 is to be within a range of ±15°.

In the above embodiment, the drip-proof structure 90 includes two drip-proof members, namely, the first drip-proof member 91 and the second drip-proof member 92, but may include three or more drip-proof members.

In the above embodiment, the first drip-proof member 91 is disposed closer to the object side than the second drip-proof member 92 in the optical axis OA direction, but the second drip-proof member 92 may be disposed closer to the object side than the first drip-proof member 91.

In the above embodiment, the case where the focusing system of the lens barrel 2 is the entire extension system has been described, but the configuration according to the present embodiment can be adopted even when the focusing system of the lens barrel 2 is other than the entire extension system. For example, even in the inner focus system in which the lens groups L1 and L2 included in the optical system block unit 100 are in an intermediate portion in the imaging optical system, the optical system block unit 100 may be supported by the first to third guide grooves 11a to 11c.

In the above embodiment, the first drip-proof member 91 and the second drip-proof member 92 are provided between the lens holding frame F1 and the second fixed barrel member 13b, which are relatively movable in the optical axis OA direction and are not relatively rotatable in the circumferential direction. For example, the drip-proof structure 90 may be applied to a gap between two frames that are relatively movable in the optical axis OA direction and relatively rotatable in the circumferential direction, for example, a gap between a lens holding frame and a focus operation ring.

Further, the stepping motor 301 is disposed above the optical axis center in FIG. 8, but its position can be changed as appropriate in accordance with the positional relationship with other members in the lens barrel 2. For example, the stepping motor 301 is preferably positioned so as not to interfere with the electrical contact between the camera body 3 and the lens barrel 2 or with the substrate arranged in a direction perpendicular to the optical axis.

The above-described embodiments are preferred examples. However, the present disclosure does not intend to suggest any limitation, and various modifications can be made without departing from the gist of the present disclosure, any combination of the constituent elements may be used.

1. A lens barrel comprising:
a first frame that holds a lens;
a drive unit that includes a drive shaft and drives the first frame in a direction of an optical axis; and
a second frame including at least two guide portions that guide driving of the first frame in the direction of the optical axis,
wherein in a plane orthogonal to the optical axis, at least one of the at least two guide portions is disposed on a second straight line, which is orthogonal to a first straight line passing through the drive shaft and the optical axis and passes through the optical axis.

2. The lens barrel according to claim 1,
wherein at least one of the at least two guide portions has a linear groove disposed along the direction of the optical axis, and
wherein the first frame has a protrusion that protrudes outward from an outer periphery of the first frame and is guided along the linear groove.

3. The lens barrel according to claim 2, wherein a bottom surface on an object side of the linear groove in the optical axis direction is located radially further outward than a bottom surface on an image plane side of the linear groove.

4. The lens barrel according to claim 2, wherein the first frame includes a rotation portion that is provided on the protrusion and is rotatable.

5. The lens barrel according to claim 4,
wherein the rotation portion includes an inner ring fixed to the protrusion and an outer ring rotatable relative to the inner ring, and
wherein an outer peripheral surface of the outer ring is in contact with the linear groove.

6. The lens barrel according to claim 1, wherein the at least two guide portions include first and second guide portions disposed on the second straight line and a third guide portion different from the first and second guide portions.

7. The lens barrel according to claim 6, wherein the third guide portion is disposed on the first straight line.

8. The lens barrel according to claim 1,
wherein the drive unit includes:
a lead screw;
a ring-shaped member;
a moving member that rotatably holds the ring-shaped member and moves in an axial direction of the lead screw in accordance with rotation of the lead screw; and
a biasing portion that biases the ring-shaped member toward the lead screw in a direction orthogonal to the axial direction of the lead screw.

9. A lens barrel comprising:
a first frame that holds a lens;
a drive unit that includes a drive shaft and drives the first frame in an optical axis direction;
a second frame including at least two guide portions that guide driving of the first frame in the optical axis direction;
an inner ring fixed to the first frame; and
an outer ring rotatable relative to the inner ring,
wherein an outer peripheral surface of the outer ring is in contact with the guide portion.

10. A lens barrel including a first frame and a second frame that move relative to each other in an optical axis direction, the lens barrel comprising:
at least two drip-proof members provided in a gap that is between the first frame and the second frame and connects an exterior and interior of the lens barrel.

11. The lens barrel according to claim 10,
wherein the first frame holds a lens, and
wherein the second frame is disposed radially further outward than the first frame.

12. The lens barrel according to claim 10,
wherein the at least two drip-proof members include a first drip-proof member and a second drip-proof member, and
wherein the first drip-proof member has a higher water repellency than the second drip-proof member.

13. The lens barrel according to claim 12,
wherein the first drip-proof member and the second drip-proof member are arranged side by side in an optical axis direction, and
wherein the first drip-proof member is disposed closer to the object side than the second drip-proof member.

14. The lens barrel according to claim 12,
wherein the first drip-proof member and the second drip-proof member are arranged side by side in an optical axis direction, and
wherein the second drip-proof member is disposed closer to the object side than the first drip-proof member.

15. The lens barrel according to claim 12,
wherein the first drip-proof member and the second drip-proof member are arranged side by side in an optical axis direction, and
wherein a thickness of at least a part of the first drip-proof member is larger than a thickness of at least a part of the second drip-proof member.

16. The lens barrel according to claim 12, wherein the first frame is movable in the optical axis direction with respect to the second frame, and the first frame and the second frame do not relatively rotate in a circumferential direction.

17. The lens barrel according to claim 12, wherein a gap is provided between the first drip-proof member and the first frame.

18. An imaging device comprising the lens barrel according to claim 1.
